(19) United States
(12) Patent Application Publication
(10) Pub. No.: US 2026/0356046 A1
(43) Pub. Date: Nov. 12, 2026

(54) PRODUCTION METHOD FOR EYE MEMBER, PRODUCTION METHOD FOR THREE-DIMENSIONAL SHAPED OBJECT, EYE MEMBER, AND THREE-DIMENSIONAL SHAPED OBJECT

(71) Applicant: The Pokémon Company, Tokyo (JP)

(72) Inventors: Junichi MASUDA, Tokyo (JP); Kazunori YANAGISAWA, Chiba (JP); Rie SHIMAMURA, Chiba (JP)

(73) Assignee: The Pokémon Company, Tokyo (JP)

(21) Appl. No.: 19/719,410

(22) Filed: Jun. 25, 2026

Related U.S. Application Data
(63) Continuation of application No. PCT/JP2025/001491, filed on Jan. 20, 2025.

(30) Foreign Application Priority Data
Mar. 1, 2024 (JP) 2024-031484

(51) Int. Cl. B29C 64/393; B33Y 50/02; B33Y 80/00

(52) U.S. Cl. CPC B29C 64/393; B33Y 50/02; B33Y 80/00

(57) ABSTRACT

A production method to efficiently produce an eye member to be attached to a three-dimensional shaped object includes acquiring 3D data of an eye member including an eyeball portion that includes a base portion and a covering portion positioned on one side of the base portion so as to cover the base portion, wherein the base portion includes a pupil portion provided on a surface on the one side of the base portion and a peripheral portion positioned at a periphery of the pupil portion and inclined at a predetermined angle toward the one side from the pupil portion; generating instruction data for instructing a 3D printer to shape the eye member on a basis of the 3D data; and shaping the eye member by causing the 3D printer to eject a shaping material on a basis of the instruction data.

### CROSS-REFERENCE TO RELATED APPLICATIONS

The present disclosure is a bypass continuation of International Application No. PCT/JP2025/001491, filed on Jan. 20, 2025, and claims priority to Japanese Patent Application No. 2024-031484, filed on Mar. 1, 2024, each are incorporated herein by reference in its entirety.

### TECHNICAL FIELD

The present disclosure relates to a production method for an eye member and a production method for a three-dimensional shaped object.

### BACKGROUND

There is a technology for producing an eye member in which an eye of a three-dimensional shaped object that imitates a character appears to achieve a pursuit effect of following a person viewing the three-dimensional shaped object.

### CITATION LIST

### Patent Literature

[PTL 1] Japanese Patent Application Laid-open No. 2022-074525

### SUMMARY

### Technical Problems

PTL 1 describes a production method for an eye component that is assembled into a facial component of a doll body, the production method including: an iris-portion forming step of forming an iris portion that covers a front surface of the eye component; a pupil-portion forming step of forming a pupil portion that includes a front surface formed into a convex shape and includes a protruding portion that protrudes from a rear surface of the iris portion into the iris portion; and an undercoat-portion forming step of forming an undercoat portion so as to contact the rear surface of the iris portion in a portion where the pupil portion is not formed.

The degree of the pursuit effect of the eye member varies depending on the design (such as the position, color, shape, or size) of each portion constituting the eye member. Accordingly, in order to achieve a natural pursuit effect, it is necessary to repeat trial production while adjusting the design of each portion. Meanwhile, the eye member that achieves a pursuit effect is produced by combining a plurality of components or repeating molding of a plurality of materials having different colors or materials, and thus trial production requires a great number of man-hours.

Furthermore, it has been often employed to use an eye member that achieves a pursuit effect in a three-dimensional shaped object as a human motif. Therefore, much knowledge for producing eye members that achieve a pursuit effect in human motifs has been accumulated. Accordingly, when an eye member that achieves a pursuit effect is newly designed in a human motif, conventional designs can serve as references, thereby making it possible to reduce the number of man-hours required for design and trial production. On the other hand, when a motif character of a three-dimensional shaped object is an imaginary creature, the design of an eye may be unique. Furthermore, the degree of a pursuit effect that is natural for a person viewing a character varies depending on the positional and size relationships between the eyes, face, and entire body of the character. On the other hand, when a motif character of a three-dimensional shaped object is an imaginary creature, the positional and size relationships between the eyes, face, and entire body of the character may be unique. For the above reasons, there are many cases in which conventional knowledge cannot serve as references when designing an eye member that achieves a pursuit effect. When a motif character of a three-dimensional shaped-object is an imaginary creature, the shape of an eye differs depending on the design. Accordingly, when designing an eye member that achieves a pursuit effect, it is difficult to refer to the design of an eye member using another character as a motif that was previously produced. Furthermore, it is also necessary to carefully examine the strength and safety of a produced eye member due to its unique design. For the above reasons, when an eye member is produced using a character of an imaginary creature as a motif, it is necessary to repeat design and trial production in order to establish an appropriate design, which requires a great number of man-hours as compared with a case of a three-dimensional shaped object using a human as a motif.

For the above reasons, there has been a demand for a method for efficiently producing an eye member to be attached to a three-dimensional shaped object.

### Solutions to Problems

An object of the present disclosure is to efficiently produce an eye member to be attached to a three-dimensional shaped article.

A production method for an eye member to be attached to a three-dimensional shaped object, including: a step of acquiring 3D data of an eye member including an eyeball portion that includes a base portion and a covering portion positioned on one side of the base portion so as to cover the base portion, wherein the base portion includes a pupil portion provided on a surface on the one side of the base portion and a peripheral portion positioned at a periphery of the pupil portion and inclined at a predetermined angle toward the one side from the pupil portion; a step of generating instruction data for instructing a 3D printer to shape the eye member on a basis of the 3D data; and a step of shaping the eye member by causing the 3D printer to eject a shaping material on a basis of the instruction data.

### Advantageous Effects

According to the present disclosure, an eye member that achieves a pursuit effect can be efficiently produced.

### BRIEF DESCRIPTION OF DRAWINGS

FIG. 1 is a schematic view illustrating a process for producing a three-dimensional shaped object according to the present embodiment.

FIG. 2 is a front view of an eye member produced in the present embodiment.

FIG. 3 is a cross-sectional view of the eye member taken along line A-A in the present embodiment.

FIG. 4 is another example of a cross-sectional view of the eye member taken along line A-A.

FIG. 5 is another example of a cross-sectional view of the eye member taken along line A-A.

FIG. 6 is a block diagram illustrating a functional configuration of a system.

FIG. 7 is a block diagram illustrating a function configuration of a terminal device.

FIG. 8 is a diagram illustrating a data structure of object information.

FIG. 9 is a flowchart illustrating instruction data generation processing according to the present embodiment.

FIG. 10 is a flowchart illustrating shaping processing according to the present embodiment.

FIG. 11 is a block diagram illustrating a basic hardware configuration of a computer.

### DESCRIPTION OF EMBODIMENTS

An embodiment of the present disclosure will be described in detail below on the basis of the drawings. Note that in the drawings used to illustrate the embodiment, the same constituent elements are, in principle, denoted by the same reference numerals, and repeated descriptions thereof will be omitted.

### 0. Outline of Three-Dimensional Shaped Object

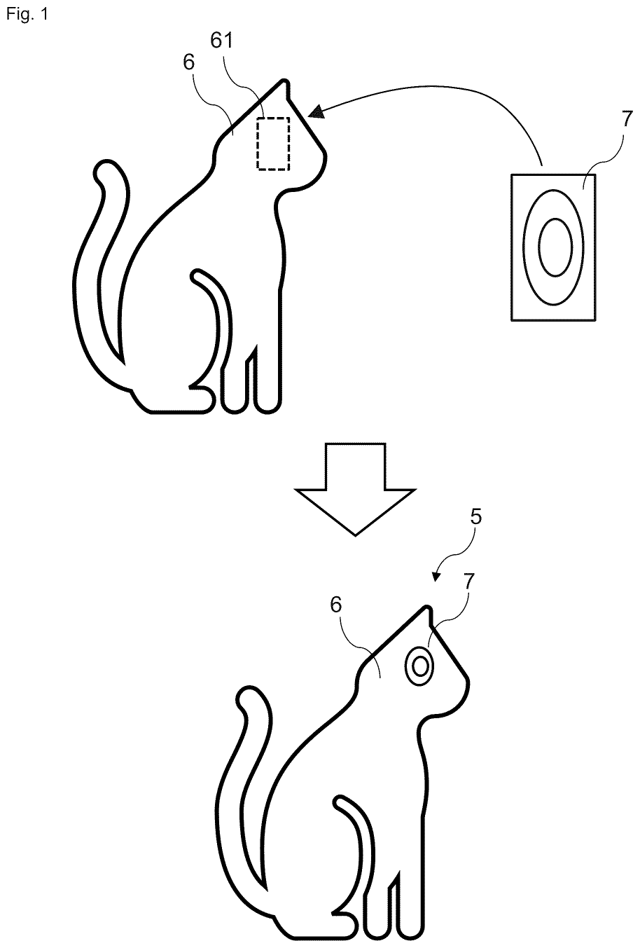

FIG. 1 is a schematic view illustrating a process for producing a three-dimensional shaped object 5 according to the present embodiment. In the present embodiment, the three-dimensional shaped object 5 is a three-dimensional shaped object that imitates a character of a specific imaginary creature. Note that the object to be produced as the three-dimensional shaped object 5 is not limited to an imaginary creature. The three-dimensional shaped object 5 may also imitate an imaginary artifact, an actual creature, an actual man-made object, or the like. Note that in the present embodiment, it is not assumed that the three-dimensional shaped object 5 includes an object that imitates a human.

Furthermore, in particular, the three-dimensional shaped object 5 produced in the present embodiment is an object that imitates a specific character and is installed in a tourist facility such as a theme park or an amusement park. The three-dimensional shaped object 5 is produced so as to reproduce, for example, an assumed size. By installing the three-dimensional shaped object 5 in a tourist facility, the world of a story in which the character appears is created within the facility. Furthermore, users of the facility can enhance their experience by viewing the three-dimensional shaped object 5 from various angles or by capturing videos or photographs thereof. Note that the installation location of the three-dimensional shaped object 5 is not limited to a tourist facility, and it may be installed in various locations depending on the purpose.

As illustrated in FIG. 1, the three-dimensional shaped object 5 includes a body portion 6 that imitates a body portion of a character and an eye member 7 that imitates an eye portion of the character.

The body portion 6 includes an attachment region 61 for attaching the eye member 7. The attachment region 61 includes, for example, a recess corresponding to the shape of the eye member 7. For example, when the eye member 7 imitates an eyeball portion of a character, the attachment region 61 includes a recess having a shape along the contour of the eyeball of the character. Furthermore, for example, when the eye member 7 imitates an eyeball portion of a character and a skin portion around the eyeball, the attachment region 61 may include a recess having a shape along the contour of the skin portion imitated by the eye member 7. The eye member 7 is attached to the attachment region 61 by being embedded in the recess of the attachment region 61. When the eye member 7 is embedded in the recess, the eye member 7 may be fixed to the attachment region 61 by, for example, fitting, fastening with bolts and nuts, welding, bonding with an adhesive, or the like.

With reference to FIG. 1, a process for producing the three-dimensional shaped object 5 will be described. First, the body portion 6 is produced by any shaping method. Furthermore, the eye member 7 is produced using a 3D printer. Then, the three-dimensional shaped object 5 is produced by attaching the eye member 7 to the attachment region 61 of the body portion 6. When the eye member 7 is attached to the attachment region 61, surface processing such as polishing, painting, or filling with a filler may be performed on a boundary between the attachment region 61 and the eye member 7. As a result, the boundary between the attachment region 61 and the eye member 7 becomes less conspicuous.

In the present embodiment, the body portion 6 is produced using, for example, FRP (Fiber Reinforced Plastics). However, the material of the body portion 6 is not limited to FRP. The material of the body portion 6 may also be a metal such as iron or steel, a resin such as polyurethane or acrylic, wood, or the like. Furthermore, in the present embodiment, the eye member 7 is made of, for example, an acrylic resin. However, the material of the eye member 7 is not limited thereto. The material of the eye member 7 may also be a natural resin, a synthetic resin, gypsum, metal powder, or the like.

### 0.1. Details of Eye Member

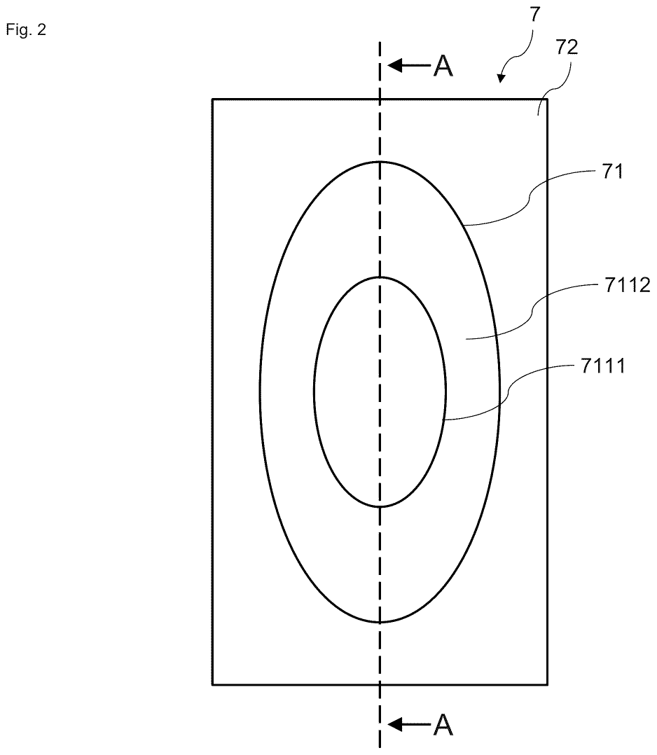

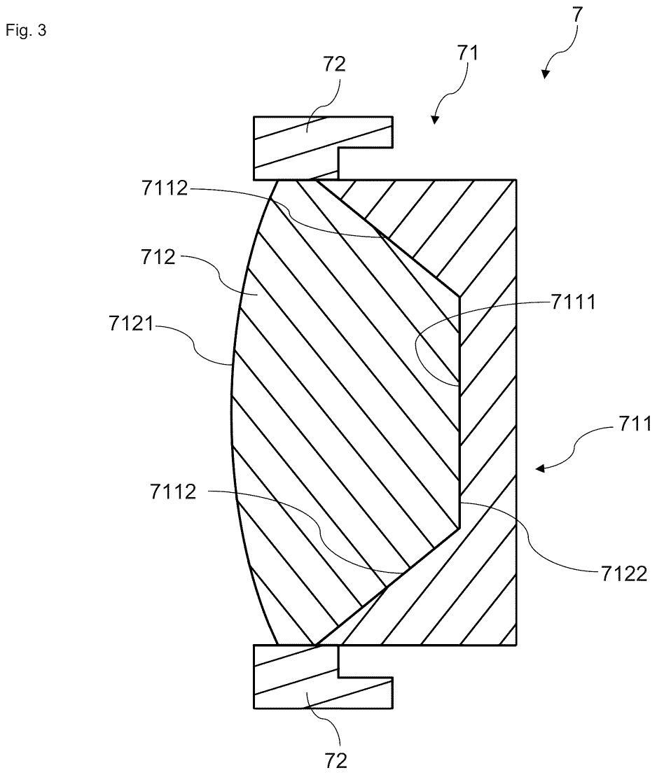

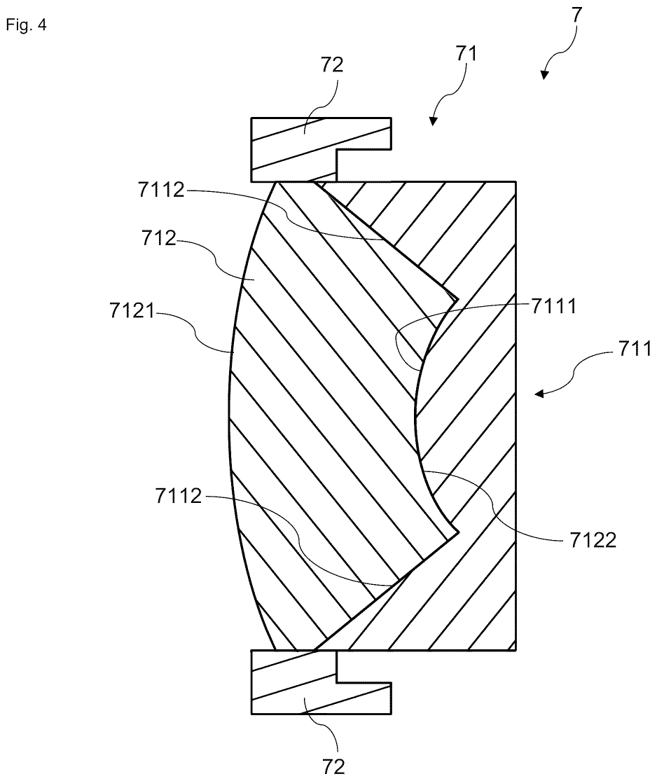

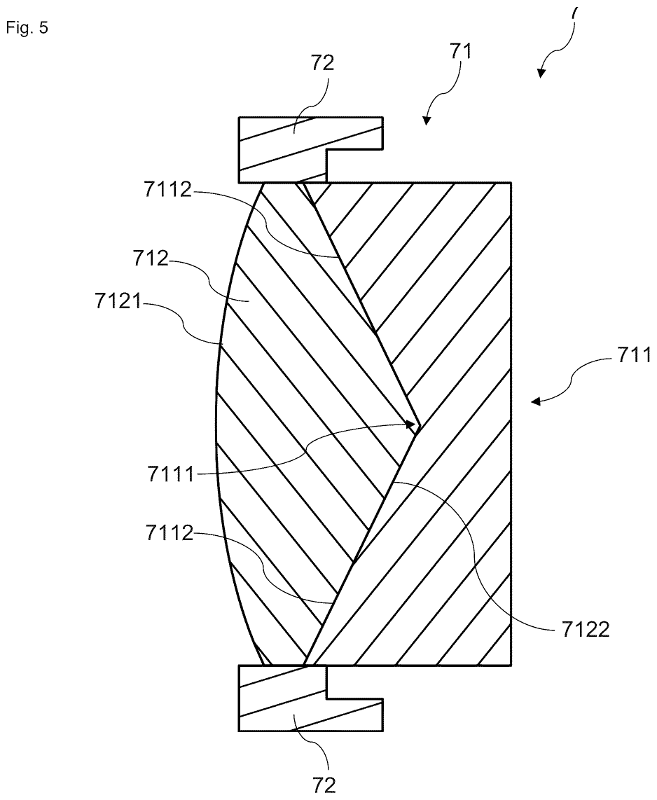

FIG. 2 is a front view of the eye member 7 produced in the present embodiment. FIG. 3 is a cross-sectional view of the eye member 7 taken along line A-A in the present embodiment. FIG. 4 is another example of a cross-sectional view of the eye member 7 taken along line A-A. FIG. 5 is another example of a cross-sectional view of the eye member 7 taken along line A-A. As illustrated in FIG. 2, the eye member 7 includes an eyeball portion 71 and a body region 72. Note that the eye member 7 may not include the body region 72.

The eyeball portion 71 is a portion that imitates an eyeball of a character. As illustrated in FIG. 3, the eyeball portion 71 includes a base portion 711 and a covering portion 712.

The base portion 711 is a portion that serves as a base of the eyeball portion 71. As illustrated in FIG. 3, the base portion 711 includes a pupil portion 7111 and a peripheral portion 7112.

The pupil portion 7111 is a portion that imitates the pupil of an eyeball of a character. As illustrated in FIG. 3, the pupil portion 7111 is provided at the center of the base portion 711 on a surface on the one side of the base portion 711. Note that the pupil portion 7111 may not be provided at the center of the base portion 711. As illustrated in FIG. 3, the pupil portion 7111 has, for example, a planar shape. Note that as illustrated in FIG. 4, the pupil portion 7111 may have a curved surface shape. The curved surface shape of the pupil portion 7111 may be, for example, a convex shape as illustrated in FIG. 4, a concave shape, or another shape. Furthermore, as illustrated in FIG. 5, the pupil portion 7111 may correspond to a vertex portion of a corner formed by the peripheral portion 7112 in the base portion 711. The degree of the pursuit effect of the eye member 7 varies depending on parameters such as the position (in particular, the position relative to the peripheral portion 7112 and a first surface 7121 of the covering portion 712), color, shape, or size of the pupil portion 7111. Therefore, in order to achieve an appropriate pursuit effect for a character to be shaped, a designer of the eye member 7 adjusts parameters such as the position (in particular, the position relative to the peripheral portion 7112 and the first surface 7121 of the covering portion 712), color, shape, or size of the pupil portion 7111.

The peripheral portion 7112 is a portion that imitates a peripheral portion of the pupil of a character. For example, the peripheral portion 7112 may represent a black portion of an eyeball of a character. The peripheral portion 7112 is positioned at the periphery of the pupil portion 7111 and is provided so as to be inclined at a predetermined angle toward one side from the pupil portion 7111. The degree of the pursuit effect of the eye member 7 varies depending on parameters such as the position, color, shape, or size (in particular, an inclination angle from the pupil portion 7111) of the peripheral portion 7112. Therefore, in order to achieve an appropriate pursuit effect for a character to be shaped, a designer of the eye member 7 adjusts the color, shape, and size (in particular, the inclination angle from the pupil portion 7111) of the peripheral portion 7112.

The pupil portion 7111 and the peripheral portion 7112 are made of materials having different appearances. Here, the term “different appearances” means that a difference in appearance arises, for example, when at least any one of material, color, and transparency is different. As a result, a difference in appearance between a pupil portion of an eyeball of a character and a peripheral portion of the pupil is expressed.

Furthermore, the base portion 711 may include, at a further periphery of the peripheral portion 7112, a portion having an appearance different from that of the peripheral portion 7112. This portion may represent, for example, a white portion of an eyeball of a character.

The covering portion 712 is a portion that imitates a surface (corneal portion) of an eyeball of a character. As illustrated in FIG. 3, the covering portion 712 is positioned on one side of the base portion 711 so as to cover the base portion 711. The covering portion 712 is made of a material that transmits light. As a result, as illustrated in FIG. 2, when the eye member 7 is viewed from one side of the covering portion 712, the appearances of the pupil portion 7111 and the peripheral portion 7112 can also be visually recognized through the covering portion 712.

Furthermore, as illustrated in FIG. 3, the covering portion 712 includes a first surface 7121 that is exposed to the outside and is not in contact with the pupil portion 7111, and a second surface 7122 that is not exposed to the outside and is in contact with the pupil portion 7111. The first surface 7121 has a curved surface shape. The degree of the pursuit effect of the eye member 7 varies depending on parameters such as the position, color, shape (in particular, a distance between the first surface 7121 and the pupil portion 7111), or size (in particular, a size and curvature of the first surface 7121) of the covering portion 712. Therefore, in order to achieve an appropriate pursuit effect for a character to be shaped, a designer of the eye member 7 adjusts parameters such as the position, color, shape (in particular, the distance between the first surface 7121 and the pupil portion 7111), or size (in particular, the size and curvature of the first surface 7121) of the covering portion 712.

Note that the second surface 7122 may not be in contact with the pupil portion 7111. In this case, a region between the second surface 7122 and the pupil portion 7111 may be filled with a predetermined light-transmitting material or may be hollow.

As illustrated in FIGS. 3 to 5, the pupil portion 7111 is provided so as to be positioned at a predetermined distance on an opposite side relative to the first surface 7121 of the covering portion 712, whereby the pupil portion 7111 can appear to follow a person viewing the eye member 7 (such that the pupil portion 7111 achieves a pursuit effect). As described above, the degree of the pursuit effect of the eye member 7 varies depending on parameters such as the positions, colors, shapes, or sizes of the pupil portion 7111, the peripheral portion 7112, and the covering portion 712 (including the first surface 7121 and the second surface 7122). Therefore, in order to achieve an appropriate pursuit effect for a character to be shaped, it is necessary to adjust these parameters. Accordingly, in order to achieve an appropriate pursuit effect for a character to be shaped, it is necessary to repeat designing and trial production of the eye member 7 while adjusting these parameters.

The body region 72 is a portion that imitates a skin portion around an eyeball of a character. As illustrated in FIGS. 2 and 3, the body region 72 is provided so as to be in contact with the eyeball portion 71. Furthermore, as illustrated in FIG. 2, the body region 72 is provided so as to surround the eyeball portion 71. The body region 72 is made of a material having an appearance similar to that of a vicinity of the attachment region 61 of the body portion 6. As a result, when the eye member 7 is attached to the attachment region 61, a boundary between the body portion 6 and the eye member 7 becomes less conspicuous, and the three-dimensional shaped object 5 can present a natural appearance.

### 1. Configuration Diagram of Overall System

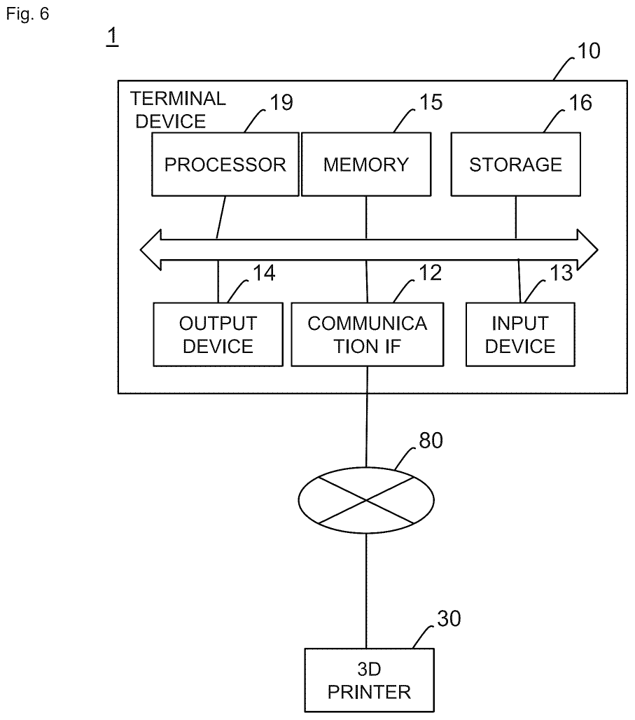

FIG. 6 is a block diagram illustrating an example of an overall configuration of a system 1. The system 1 illustrated in FIG. 6 includes, for example, a terminal device 10 and a 3D printer 30. The terminal device 10 and the 3D printer 30 are connected to each other via, for example, a network 80.

The terminal device 10 illustrated in FIG. 6 is realized, for example, by a stationary PC (Personal Computer) or a laptop PC. Alternatively, the terminal device 10 may be realized, for example, by a mobile terminal such as a smartphone or a tablet corresponding to a mobile communication system. Furthermore, the terminal device 10 may be realized, for example, by a wearable terminal such as an HMD (Head-Mount Display).

The terminal device 10 includes a communication IF (Interface) 12, an input device 13, an output device 14, a memory 15, a storage 16, and a processor 19. The input device 13 is a device (e.g., a mouse, a keyboard, or the like) for receiving an input operation from a user. The output device 14 is a device (e.g., a display, a speaker, or the like) for presenting information to a user.

The terminal device 10 is configured by a computer including a processing device and a storage device. A basic hardware configuration of the computer and a basic functional configuration of the computer realized by the hardware configuration will be described later. For the terminal device 10, descriptions overlapping the basic hardware configuration of the computer and the basic functional configuration of the computer described later will be omitted.

The 3D printer 30 is a shaping device that shapes the eye member 7 in accordance with information transmitted from the terminal device 10. The 3D printer 30 shapes the eye member 7 using a shaping material according to any method such as a material extrusion method, an optical shaping method, or an inkjet method. The 3D printer 30 includes, for example, an ejection unit that ejects a shaping material, and a platform on which the ejected shaping material is laminated. Furthermore, in the present embodiment, the ejection unit of the 3D printer 30 is capable of selectively ejecting a plurality of different shaping materials. Note that the 3D printer 30 may also shape the body portion 6 according to any method.

### Configuration of Terminal Device

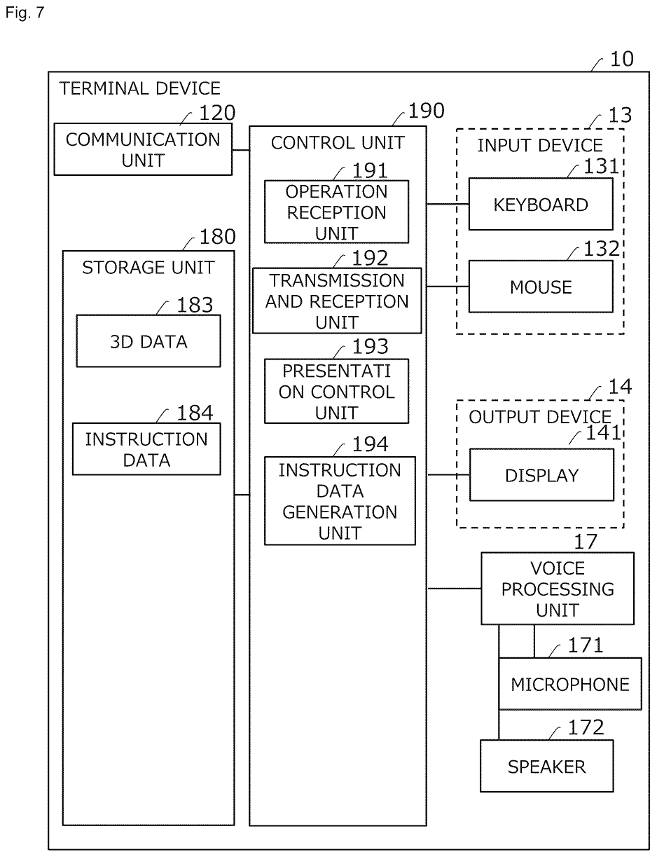

FIG. 7 is a block diagram illustrating a configuration example of the terminal device 10 shown in FIG. 6. As illustrated in FIG. 7, the terminal device 10 includes a communication unit 120, the input device 13, the output device 14, a voice processing unit 17, a microphone 171, a speaker 172, a position information sensor 150, a camera 160, a motion sensor 170, a storage unit 180, and a control unit 190. The respective blocks included in the terminal device 10 are electrically connected to one another via, for example, a bus.

The communication unit 120 performs processing such as modulation and demodulation processing required for the terminal device 10 to communicate with another device. The communication unit 120 performs transmission processing on a signal generated by the control unit 190 and transmits the signal to the outside (e.g., the server). The communication unit 120 performs reception processing on a signal received from the outside and outputs the signal to the control unit 190.

The input device 13 is a device that allows a user operating the terminal device 10 to input instructions or information. The input device 13 is realized, for example, by a reader, a keyboard 131, a mouse 132, or the like. When the terminal device 10 is a smartphone, the input device 13 may be realized by a touch-sensitive device or the like in which instructions are input by touching an operation surface. The input device 13 converts instructions input from a user into an electrical signal and outputs the electrical signal to the control unit 190. Note that the input device 13 may also include, for example, a reception port that receives an electrical signal input from an external input device.

The output device 14 is a device that presents information to a user operating the terminal device 10. The output device 14 is realized, for example, by a display 141 or the like. The display 141 displays data in accordance with control of the control unit 190. The display 141 is realized, for example, by an LCD (Liquid Crystal Display), an organic EL (Electro-Luminescence) display, or the like.

The voice processing unit 17 performs, for example, digital-to-analog conversion processing on an audio signal. The voice processing unit 17 converts a signal supplied from the microphone 171 into a digital signal and supplies the converted signal to the control unit 190. Furthermore, the voice processing unit 17 supplies an audio signal to the speaker 172. The voice processing unit 17 is realized, for example, by a processor for voice processing. The microphone 171 receives voice input and supplies an audio signal corresponding to the voice input to the voice processing unit 17. The speaker 172 converts an audio signal supplied from the voice processing unit 17 into sound and outputs the sound to the outside of the terminal device 10.

The position information sensor 150 is a sensor that detects the position of the terminal device 10 and is, for example, a GPS (Global Positioning System) module. The GPS module is a reception device used in a satellite positioning system. In the satellite positioning system, signals from at least three or four satellites are received, and the current position of the terminal device 10 equipped with the GPS module is detected on the basis of the received signals. The position information sensor 150 may also detect the current position of the terminal device 10 on the basis of the position of a radio base station to which the terminal device 10 is connected.

The storage unit 180 is realized, for example, by the memory 15, the storage 16, or the like and stores data and programs used by the terminal device 10. The storage unit 180 stores, for example, 3D data 183 and instruction data 184.

The 3D data 183 is data related to a 3D object representing the three-dimensional shape of the eye member 7. The 3D data 183 is stored in the storage unit 180 in any format such as an obj file. The 3D data 183 may include data related to a 3D object of the body portion 6.

In the 3D data 183, 3D objects of the eye member 7 are formed such that the 3D objects of respective portions included in the eye member 7 can be distinguished from one another. For example, the 3D objects of the eye member 7 are formed such that a 3D object of the eyeball portion 71 can be distinguished from a 3D object of the body region 72. Furthermore, for example, the 3D objects of the eyeball portion 71 are formed such that a 3D object of the base portion 711 can be distinguished from and a 3D object of the covering portion 712. Furthermore, for example, the 3D object of the base portion 711 is formed such that a 3D object of the pupil portion 7111 can be distinguished from a 3D object of the peripheral portion 7112.

The 3D data 183 includes object information 1831, which is information related to a 3D object associated with the 3D data 183. Note that the 3D data 183 may not include some or all of the information included in the object information 1831, and some or all of the information included in the object information 1831 may be stored in the storage unit 180 in association with the 3D data 183.

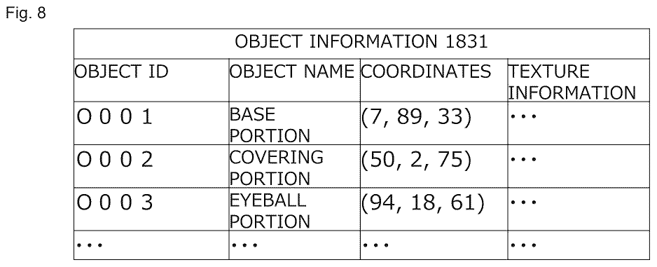

FIG. 8 is a diagram illustrating an example of a data structure of the object information 1831. Note that FIG. 8 is merely an example and does not exclude data that is not shown. The object information 1831 includes an item “object ID,” an item “object name,” an item “coordinates,” and an item “texture information”.

The item “object ID” is an item for storing object IDs for identifying objects. The object IDs are used to identify, for example, a 3D object of the eye member 7 and 3D objects of respective portions (the eyeball portion 71, the body region 72, the base portion 711, the covering portion 712, the pupil portion 7111, and the peripheral portion 7112) of the eye member 7. In the 3D data 183, when another 3D object (child object) is included in a predetermined 3D object (parent object), the object ID of the parent object and the object ID of the child object may be associated with each other in accordance with a group structure, a hierarchical structure, or the like. For example, in the present embodiment, the object ID of the 3D object of the eye member 7, the object ID of the 3D object of the eyeball portion 71, and the object ID of the 3D object of the body region 72 may be associated with each other.

The item “object name” is an item for storing names of objects.

Specifically, the item “object name” stores names of predetermined portions of an object to be shaped, the portions corresponding to 3D objects identified by object IDs. For example, the item “object name” stores names representing the base portion 711, the covering portion 712, and the like, which are included in the eye member 7.

The item “coordinates” is an item for storing coordinate values representing positions of 3D objects.

Specifically, the item “coordinates” stores values of x-coordinates, y-coordinates, and z-coordinates of 3D objects. For example, the item “coordinates” stores values of central coordinates of 3D objects.

The item “texture information” is an item for storing information related to textures of 3D objects.

Specifically, the item “texture information” stores information related to visual effects applied to surfaces of 3D objects. For example, the item “texture information” stores information related to colors, gloss, roughness, transparency, or the like of surfaces of 3D objects.

The instruction data 184 is data in which contents of operation instructions for instructing the 3D printer 30 to shape the eye member 7 are described. Specifically, the instruction data 184 includes information related to any setting item corresponding to a shaping method of the 3D printer 30. For example, the instruction data 184 includes information related to a setting of a movement path of an ejection unit of the 3D printer 30, and information related to control settings of the ejection unit, information related to settings (such as temperature settings, light irradiation settings, or the like) for solidifying an ejected shaping material, or the like. The instruction data 184 is represented by, for example, G-code.

The control unit 190 is realized when the processor 19 reads a program stored in the storage unit 180 and executes instructions included in the program. The control unit 190 controls operations of the terminal device 10. The control unit 190 operates in accordance with the program, thereby exhibiting functions of an operation reception unit 191, a transmission and reception unit 192, a presentation control unit 193, and an instruction data generation unit 194.

The operation reception unit 191 performs processing for receiving instructions or information input from the input device 13. For example, the operation reception unit 191 receives instructions or information input from the keyboard 131, the mouse 132, or the like.

Furthermore, the operation reception unit 191 receives voice information input from the microphone 171. Specifically, for example, the operation reception unit 191 receives voice data that is input from the microphone 171 and converted into digital data by the voice processing unit 17.

The transmission and reception unit 192 performs processing for causing the terminal device 10 to transmit and receive data to and from an external device in accordance with a communication protocol.

The presentation control unit 193 controls the output device 14 or the like in order to present information, such as information provided to a user by execution of a program stored in the storage unit 180 or information provided to the user from the 3D printer 30.

The instruction data generation unit 194 generates the instruction data 184 on the basis of the 3D data 183. Specifically, the instruction data generation unit 194 slices the 3D object of the eye member 7 related to the 3D data 183 into a plurality of layers overlapping in a direction perpendicular to a predetermined plane (e.g., a z-axis direction defined in the 3D data 183) along the predetermined plane (e.g., an x-y plane defined in the 3D data 183), and outputs the instruction data 184 in which contents of operation instructions of the 3D printer 30 for shaping the plurality of layers are described.

### 2. Operation

### (Instruction Data Generation Processing)

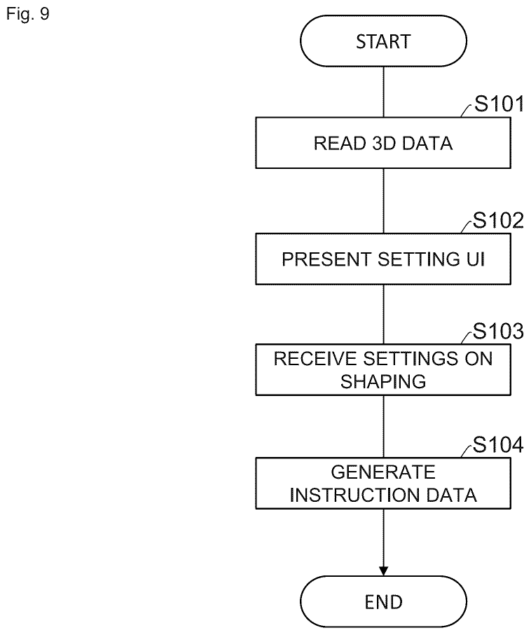

Instruction data generation processing according to the present embodiment will be described. The instruction data generation processing is processing for generating the instruction data 184 on the basis of the 3D data 183. FIG. 9 is a flowchart illustrating the instruction data generation processing according to the present embodiment.

A user performs modeling of the eye member 7 in advance using predetermined modeling software to generate the 3D data 183. At this time, in order to cause the pupil portion 7111 to appear to follow a person viewing the three-dimensional shaped object 5, the position, shape, and size of the pupil portion 7111, the inclination angle of the peripheral portion 7112, and the shape of the covering portion 712, which are included in the eye member 7, are designed. As a result, the three-dimensional shaped object 5 including the eye member 7 appears to achieve a pursuit effect of following a person viewing the three-dimensional shaped object 5. The user stores the generated 3D data 183 in the storage unit 180 of the terminal device 10.

In step S101, the terminal device 10 acquires the 3D data 183 from the storage unit 180.

Specifically, the terminal device 10 acquires the 3D data 183 from the storage unit 180 in response to a user operation. The terminal device 10 starts a predetermined application program (e.g., any slicer software) and reads the 3D data 183.

In step S102, the terminal device 10 presents a setting UI related to generation of the instruction data 184 to the user. Specifically, the terminal device 10 generates the setting UI on the basis of the 3D data 183 read in step S101 and presents the setting UI to the user via the display 141.

The setting UI includes, for example, a region for displaying the 3D object of the eye member 7 and the 3D objects of respective portions included in the eye member 7.

Furthermore, the setting UI includes a region for displaying setting items for shaping for each object ID of the object information 1831. The terminal device 10 displays, for example, a region for inputting setting items for each object ID by referring to each record of the object information 1831. Examples of the setting items include the following items.

(Settings on slicing 3D data)
The number of sliced layers
Interval between sliced layers
   (Settings on arrangement of a shaped object on a platform of the 3D printer 30)
The position of the shaped object on the platform
The size of the shaped object on the platform
Orientation of the shaped object on the platform
   (Settings on shaping material)
Specification of shaping material (color, transparency, material, type, etc.)
   (Settings on operations of the 3D printer 30)
Operating speed of the ejection unit
An operation path of the ejection unit
An amount of the shaping material supplied
An ejection temperature of the shaping material
Settings on solidification of the shaping material (cooling temperature of the shaping material, setting of light for irradiating the shaping material (irradiation time, irradiation wavelength, etc.))

The user performs settings on shaping of the eye member 7 by inputting information for respective setting items displayed on the setting UI. Note that in the setting UI, information may be input for each object ID for a predetermined setting item, information may be input for each of any plurality of object IDs, or information may be input collectively for all object IDs. In particular, in respective portions (the eyeball portion 71, the body region 72, the base portion 711 and the covering portion 712 included in the eyeball portion 71, and the pupil portion 7111 and the peripheral portion 7112 included in the base portion 711) included in the eye member 7, the color and material of a shaping material used for shaping may be different. In this case, the terminal device 10 individually receives input of setting items for each of the object IDs corresponding to the respective portions included in the eye member 7. For example, the terminal device 10 may individually receive, for each of the object IDs corresponding to the covering portion 712, the peripheral portion 7112, and the pupil portion 7111, input of information to setting items, thereby assigning different settings to portions corresponding to the covering portion 712, the peripheral portion 7112, and the pupil portion 7111 in the 3D data 183. Furthermore, the terminal device 10 may individually receive, for each of the object IDs corresponding to the covering portion 712 and the body region 72, input of information to setting items, thereby assigning different settings to portions corresponding to the covering portion 712 and the body region 72 in the 3D data 183.

Furthermore, the setting UI includes a region for displaying a button for receiving an input operation for inputting an instruction to generate the instruction data 184. When the button receives an input operation from the user, the terminal device 10 proceeds to processing in step S103.

In step S103, the terminal device 10 receives settings on shaping of the eye member 7.

Specifically, the terminal device 10 receives information input from the user for the respective setting items of the setting UI presented in step S102. Note that the terminal device 10 may automatically perform the settings on shaping on the basis of information stored in respective items of the object information 1831 without receiving input of information from the user. For example, the terminal device 10 may assign, on the basis of texture information (e.g., information related to colors) stored in the item “texture information” in a predetermined record of the object information 1831, a setting on a shaping material (e.g., a setting on a color of the shaping material) when shaping a 3D object according to the record.

The terminal device 10 performs slicing of the 3D object of the eye member 7 on the basis of information related to respective setting items received from the user. Specifically, the terminal device 10 slices the 3D object of the eye member 7, which is set to a position, a size, and an orientation that are received from the user, into a plurality of layers in accordance with a slicing interval received from the user. Furthermore, the terminal device 10 determines, on the basis of the information related to the respective setting items received from the user, operation contents (such as a setting on a movement path of the ejection unit, a setting on control of the ejection unit, or a setting for solidifying an ejected shaping material) of the 3D printer 30 for shaping the respective layers.

In step S104, the terminal device 10 generates the instruction data 184 on the basis of the slicing result. Specifically, the terminal device 10 converts the operation contents of the 3D printer 30 determined in step S103 into the instruction data 184 executable by the 3D printer 30. For example, the terminal device 10 converts information, such as a movement path of the ejection unit of the 3D printer 30, a setting on control of the ejection unit, or a setting on temperature determined in step S103, into a G-code format, thereby generating the instruction data 184. The terminal device 10 stores the generated instruction data 184 in the storage unit 180.

### (Shaping Processing)

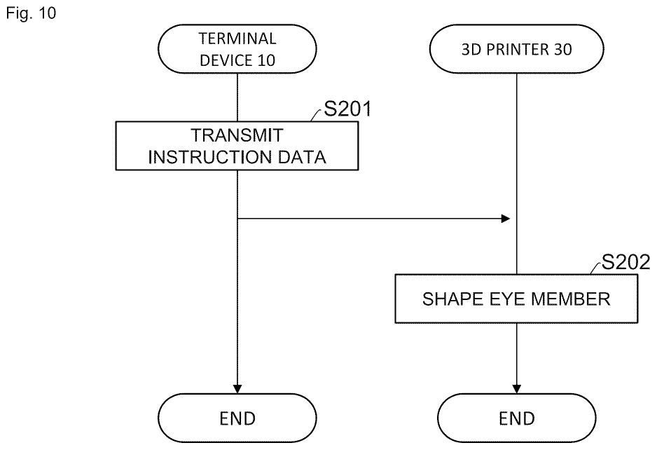

Shaping processing according to the present embodiment will be described. The shaping processing is processing for shaping the eye member 7 on the basis of the instruction data 184. FIG. 10 is a flowchart illustrating the shaping processing according to the present embodiment.

First, the terminal device 10 executes an application for controlling the 3D printer 30 on the basis of a user operation.

In step S201, the terminal device 10 transmits the instruction data 184 related to the eye member 7 to the 3D printer 30, thereby instructing the 3D printer 30 to shape the eye member 7.

Specifically, the terminal device 10 acquires the instruction data 184 related to the eye member 7 from the storage unit 180 on the basis of a user operation and transmits the instruction data 184 to the 3D printer 30.

In step S202, the 3D printer 30 shapes the eye member 7 on the basis of the instruction data 184 received from the terminal device 10.

Specifically, the 3D printer 30 reads the instruction data 184 received from the terminal device 10, causes a shaping material to be ejected from the ejection unit in accordance with instructions described in the instruction data 184, and laminates the shaping material on the platform. Then, the 3D printer 30 solidifies the shaping material laminated on the platform in accordance with the instructions described in the instruction data 184, thereby shaping the eye member 7. The shaping material used for shaping is, for example, an acrylic resin, but any shaping material may be used in accordance with the instruction data 184.

Furthermore, in step S202, the 3D printer 30 selectively ejects shaping materials assigned to respective portions of the eye member 7 in accordance with settings made in step S102 in the instruction data generation processing, thereby shaping the respective portions of the eye member 7 with different shaping materials. For example, the covering portion 712 and the base portion 711 of the eye member 7 are shaped by shaping materials having different appearances. Furthermore, for example, in the base portion 711, the pupil portion 7111 and the peripheral portion 7112 are shaped by shaping materials having different appearances. Furthermore, for example, the eyeball portion 71 and the body region 72 are shaped by shaping materials having different appearances. As a result, appearance characteristics of a character to be shaped can be satisfactorily reproduced.

Furthermore, according to the present embodiment, it is not necessary to individually produce portions having different materials in different processes, and it is possible to collectively produce the eye member in a single process. Therefore, it is possible to efficiently produce the eye member.

Furthermore, according to the present embodiment, since it is possible to collectively and efficiently produce the eye member including a plurality of portions having different materials, designs of the respective portions included in the eye member can be promptly changed. As a result, a multiplicity of prototypes can be promptly produced. Accordingly, a design for achieving an appropriate pursuit effect in the eye member can be efficiently studied.

As described above, the eye member 7 is produced through the instruction data generation processing and the shaping process. In the produced eye member 7, the base portion 711 and the covering portion 712 are made of materials having different appearances. On the other hand, as described in step S202 of the shaping processing, the base portion 711 and the covering portion 712 are integrally formed in a single process. Furthermore, in the produced eye member 7, the eyeball portion 71 and the body region 72 are made of materials having different appearances. On the other hand, as described in step S202 of the shaping processing, the eyeball portion 71 and the body region 72 are integrally formed in a single process.

Moreover, when the eye member 7 produced through the instruction data generation processing and the shaping processing is attached to the attachment region 61 of the body portion 6 shaped by any shaping method, a three-dimensional shaped object 5 including the eye member that achieves a pursuit effect is produced.

### Brief Summary

According to above-described production method, 3D data of the eye member 7 is acquired, the eye member 7 including an eyeball portion 71 that includes a base portion 711 and a covering portion 712 positioned on one side of the base portion 711 so as to cover the base portion 711, wherein the base portion 711 includes a pupil portion 7111 provided on a surface on the one side of the base portion 711 and a peripheral portion 7112 positioned at the periphery of the pupil portion 7111 and inclined at a predetermined angle toward the one side from the pupil portion 7111. Furthermore, according to the above-described production method, instruction data for instructing a 3D printer to shape the eye member 7 is generated on the basis of the 3D data. Furthermore, according to the above-described production method, the eye member 7 is shaped by causing the 3D printer to eject a shaping material on the basis of the instruction data. As a result, the eye member 7 to be attached to a three-dimensional shaped object 5 can be efficiently produced.

In the above-described production method, different settings may be assigned to portions of the 3D data corresponding to the covering portion 712, the pupil portion 7111, and the peripheral portion 7112, and a shaping material may be ejected on the basis of a setting assigned in the step of generating the instruction data. As a result, the eye member 7 including a plurality of portions having different shaping settings can be collectively and efficiently produced.

In the above-described production method, in order to cause the pupil portion 7111 to appear to follow a person viewing the three-dimensional shaped object 5, the position, shape, and size of the pupil portion 7111, the inclination angle of the peripheral portion 7112, and the shape of the covering portion 712 included in the eye member 7 may be designed. As a result, the eye member 7 that achieves a pursuit effect can be efficiently produced.

According to the above-described production method, the eye member 7 may include a body region 72 that is in contact with the eyeball portion 71, different settings may be assigned to portions corresponding to the covering portion 712 and the body region 72 in the 3D data, and a shaping material may be ejected on the basis of an assigned setting. As a result, the eye member 7 including a plurality of portions having different shaping settings can be collectively and efficiently produced.

Furthermore, as described above, the three-dimensional shaped object 5 may be produced by attaching the produced eye member 7 to the corresponding attachment region 61. As a result, the three-dimensional shaped object 5 including the eye member 7 can be efficiently produced.

Furthermore, as described above, the eye member 7 may be produced by steps including: a step of acquiring 3D data of the eye member 7, the eye member 7 including an eyeball portion 71 that includes a base portion 711 and a covering portion 712 positioned on one side of the base portion 711 so as to cover the base portion 711, wherein the base portion 711 includes a pupil portion 7111 provided on a surface on the one side of the base portion 711 and a peripheral portion 7112 positioned at the periphery of the pupil portion 7111 and inclined at a predetermined angle toward the one side from the pupil portion 7111; a step of generating instruction data for instructing a 3D printer to shape the eye member 7 on the basis of the 3D data; and a step of shaping the eye member 7 by causing the 3D printer to eject a shaping material on the basis of the instruction data. As a result, the eye member 7 to be attached to the three-dimensional shaped object 5 can be efficiently produced.

Furthermore, as described above, the three-dimensional shaped object 5 may include the eye member 7. As a result, the three-dimensional shaped object 5 including the eye member 7 can be efficiently produced.

Furthermore, as described above, the eye member 7 may include an eyeball that imitates an eyeball, the eyeball portion 71 may include a base portion 711 and a covering portion 712 positioned on one side of the base portion 711 so as to cover the base portion 711, the base portion 711 may include a pupil portion 7111 provided on a surface on the one side of the base portion 711 and a peripheral portion 7112 positioned at the periphery of the pupil portion 7111 and inclined at a predetermined angle toward the one side from the pupil portion 7111, the base portion 711 and the covering portion 712 may be made of materials having different appearances, and the base portion 711 and the covering portion 712 may be integrally formed. As a result, since the eye member 7 is integrally formed without combining individual parts, handling of the eye member 7 is facilitated and the strength of the eye member 7 is increased as compared with a case in which the eye member 7 is divided into individual parts.

Furthermore, as described above, the eye member 7 may include a body region 72 that is in contact with the eyeball portion 71 and imitates a surrounding portion of the eyeball. The eyeball portion 71 and the body region 72 may be made of materials having different appearances, and the eyeball portion 71 and the body region 72 may be integrally formed. As a result, since the eye member 7 is integrally formed without combining individual parts, handling of the eye member 7 is facilitated and the strength of the eye member 7 is increased as compared with a case in which the eye member 7 is divided into individual parts.

Furthermore, as described above, the three-dimensional shaped object 5 may include the eye member 7. As a result, since the eye member 7 is integrally formed without combining individual parts, handling of the eye member 7 is facilitated and the strength of the eye member 7 is increased as compared with a case in which the eye member 7 is divided into individual parts.

### 3. Basic Hardware Configuration of Computer

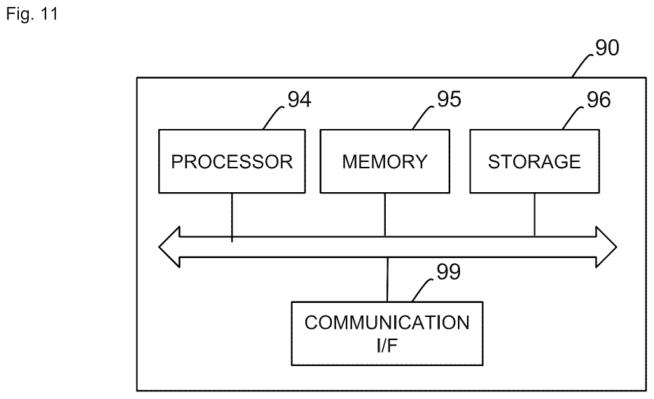

FIG. 11 is a block diagram illustrating a basic hardware configuration of a computer 90. The computer 90 includes at least a processor 94, a main storage device 95, an auxiliary storage device 96, and a communication IF 99 (Interface). These components are electrically connected to one another via a bus.

The processor 94 is hardware for executing command sets described in programs. The processor 94 is composed of an arithmetic device, a register, a peripheral circuit, and the like.

The main storage device 95 is used to temporarily store programs and data processed by the programs. For example, the main storage device 92 is a volatile memory such as a DRAM (Dynamic Random Access Memory).

The auxiliary storage device 96 is a storage device used to store data and programs. For example, the auxiliary storage device 96 is a flash memory, an HDD (Hard Disc Drive), a magneto-optical disk, a CD-ROM, a DVD-ROM, a semiconductor memory, or the like.

The communication IF 99 is an interface used to input and output signals to communicate with other computers via a network using a wired or wireless communication standard.

The network is configured by various mobile communication systems constructed by the Internet, LAN, wireless base stations, and the like. For example, the network includes 3G, 4G, and 5G mobile communication systems, LTE (Long Term Evolution), wireless networks (e.g., Wi-Fi™) connectable to the Internet through predetermined access points, and the like. In the case of wireless connection, communication protocols include, for example, Z-Wave™, ZigBee™, and Bluetooth™, and the like. In the case of wired connection, the network includes networks directly connected via USB (Universal Serial Bus) cables and the like.

Note that the computer 90 can be virtually implemented by providing all or some of hardware configurations in a plurality of computers 90 in a distributed manner and connecting the computers 90 via a network. In this manner, the computer 90 is a concept that includes not only the computer 90 accommodated in a single housing or a case but also a virtualized computer system.

### Basic Functional Configuration of Computer 90

The functional configuration of a computer implemented by the basic hardware configuration of the computer 90 illustrated in FIG. 11 will be described. The computer includes at least functional units of a control unit, a storage unit, and a communication unit.

Note that the functional units included in the computer 90 may also be implemented by providing all or some of the functional units in a plurality of computers 90 connected to one another via a network in a distributed manner. The computer 90 is a concept that includes not only a single computer 90 but also a virtualized computer system.

The control unit is implemented when the processor 94 reads various programs stored in the auxiliary storage device 96, deploys the programs on the main storage device 95, and executes processing in accordance with the programs. The control unit can implement a functional unit that performs various information processing in accordance with types of the programs. As a result, the computer is implemented as an information processing device that performs information processing.

The storage unit is implemented using the main storage device 95 and the auxiliary storage device 96. The storage unit stores data, various programs, and various databases. Furthermore, the processor 94 can secure a storage region corresponding to the storage unit in the main storage device 95 or the auxiliary storage device 96 in accordance with programs. Furthermore, the control unit can cause the processor 94 to execute addition, update, and deletion of data stored in the storage unit in accordance with various programs.

A database refers to a relational database and is used to manage data sets, which are referred to as tables structurally defined by rows and columns, in association with each other. In the database, a table is referred to as a table, a table column is referred to as a column, and a table row is referred to as a record. In the relational database, relationships between tables can be set, and the tables can be associated with each other.

Although columns as keys for uniquely identifying records are generally set in each table, it is not essential to set the keys for the columns. The control unit can cause the processor 94 to execute addition, deletion, and update of records in specific tables stored in the storage unit in accordance with various programs.

The communication unit is implemented by the communication IF 99. The communication unit has a function of communicating with other computers 90 via a network. The communication unit can receive information transmitted from other computers 90 and input the information to the control unit. The control unit can cause the processor 94 to execute information processing on the received information in accordance with various programs. Furthermore, the communication unit can transmit information output from the control unit to other computers 90.

The specification should describe the specific hardware which can be used to achieve the claimed functionality. Here is an example description of hardware which we recommend including in the U.S. application and any foreign patent application to which priority is claimed:

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

For Japanese applications which will serve as priority applications for a future U.S. application, it is important that the priority document include a similar description of the hardware. Below is Japanese language to be included in the Japanese priority application which corresponds to the above paragraph.

Although several embodiments of the present disclosure have been described above, these embodiments can be implemented in various other forms, and various omissions, replacements, and changes can be made without departing from the gist of the disclosure. These embodiments and modifications thereof are included in the claims and equivalents thereof, and are also included in the scope or gist of the disclosure.

### Appendices

Matters in the above-described embodiments will be appended below.

### (Appendix 1)

A production method for an eye member to be attached to a three-dimensional shaped object, including:
a step of acquiring 3D data of an eye member including an eyeball portion that includes a base portion and a covering portion positioned on one side of the base portion so as to cover the base portion, wherein the base portion includes a pupil portion provided on a surface on the one side of the base portion and a peripheral portion positioned at a periphery of the pupil portion and inclined at a predetermined angle toward the one side from the pupil portion;
a step of generating instruction data for instructing a 3D printer to shape the eye member on a basis of the 3D data; and
a step of shaping the eye member by causing the 3D printer to eject a shaping material on a basis of the instruction data.

### (Appendix 2)

The production method according to Appendix 1, wherein
in the step of generating the instruction data, different settings are assigned to portions of the 3D data corresponding to the covering portion, the pupil portion, and the peripheral portion, and
in the step of shaping the eye member, a shaping material is ejected on a basis of a setting assigned in the step of generating the instruction data.

### (Appendix 3)

The production method according to Appendix 1, wherein
in order to cause the pupil portion to appear to follow a person viewing the three-dimensional shaped object, a position, a shape, and a size of the pupil portion, an inclination angle of the peripheral portion, and a shape of the covering portion included in the eye member are designed.

### (Appendix 4)

The production method according to Appendix 1, wherein
the eye member includes a body region that is in contact with the eyeball portion,
in the step of generating the instruction data, different settings are assigned to portions of the 3D data corresponding to the covering portion and the body region, and
in the step of shaping the eye member, a shaping material is ejected on a basis of a setting assigned in the step of generating the instruction data.

### (Appendix 5)

A manufacturing method for a three-dimensional shaped object, including attaching the eye member produced by the production method according to any one of Appendices 1 to 4 to a corresponding attachment region.

### (Appendix 6)

An eye member to be attached to a three-dimensional shaped object, the eye member being produced by steps including:
a step of acquiring 3D data of the eye member including an eyeball portion that includes a base portion and a covering portion positioned on one side of the base portion so as to cover the base portion, wherein the base portion includes a pupil portion provided on a surface on the one side of the base portion and a peripheral portion positioned at a periphery of the pupil portion and inclined at a predetermined angle toward the one side from the pupil portion;
a step of generating instruction data for instructing a 3D printer to shape the eye member on a basis of the 3D data; and
a step of shaping the eye member by causing the 3D printer to eject a shaping material on a basis of the instruction data.

### (Appendix 7)

A three-dimensional shaped object including the eye member according to Appendix 6.

### (Appendix 8)

An eye member including an eyeball portion that imitates an eyeball, wherein
the eyeball portion includes
a base portion and
a covering portion positioned on one side of the base portion so as to cover the base portion,
the base portion includes
a pupil portion provided on a surface on the one side of the base portion and
a peripheral portion positioned at a periphery of the pupil portion and inclined at a predetermined angle toward the one side from the pupil portion,
the base portion and the covering portion are made of materials having different appearances, and
the base portion and the covering portion are integrally formed.

### (Appendix 9)

The eye member according to Appendix 8, wherein
the eye member includes a body region that is in contact with the eyeball portion and imitates a surrounding portion of the eyeball,
the eyeball portion and the body region are made of materials having different appearances, and
the eyeball portion and the body region are integrally formed.

### (Appendix 10)

A three-dimensional shaped object including the eye member according to Appendix 8 or 9.

### REFERENCE SIGNS LIST

1 System
10 Terminal device
12 Communication IF
120 Communication unit
13 Input device
131 Button
14 Output device
141 Display
15 Memory
16 Storage
17 Voice processing unit
171 Microphone
172 Speaker
180 Storage unit
19 Processor
190 Control unit
30 3D printer

1. A production method for an eye member to be attached to a three-dimensional shaped object, comprising:
acquiring 3D data of an eye member including an eyeball portion that includes a base portion and a covering portion positioned on one side of the base portion so as to cover the base portion, wherein the base portion includes a pupil portion provided on a surface on the one side of the base portion and a peripheral portion positioned at a periphery of the pupil portion and inclined at a predetermined angle toward the one side from the pupil portion;
generating instruction data for instructing a 3D printer to shape the eye member based on the 3D data; and
shaping the eye member by causing the 3D printer to eject a shaping material based on the instruction data.

2. The production method according to claim 1, further comprising:
assigning different settings to portions of the 3D data corresponding to the covering portion, the pupil portion, and the peripheral portion, and
ejecting a shaping material based on an assigned setting.

3. The production method according to claim 1, further comprising:
causing the pupil portion to appear to follow a person viewing the three-dimensional shaped object, a position, a shape, and a size of the pupil portion, based on an inclination angle of the peripheral portion and a shape of the covering portion included in the eye member.

4. The production method according to claim 1, wherein the eye member includes a body region that is in contact with the eyeball portion, the method further comprising:
assigning different settings to portions of the 3D data corresponding to the covering portion and the body region, and
ejecting a shaping material based on an assigned setting.

5. A manufacturing method for a three-dimensional shaped object, comprising:
attaching the eye member produced by the production method according to claim 1 to a corresponding attachment region.

6. An eye member to be attached to a three-dimensional shaped object, the eye member being produced by steps comprising:
acquiring 3D data of the eye member including an eyeball portion that includes a base portion and a covering portion positioned on one side of the base portion so as to cover the base portion, wherein the base portion includes a pupil portion provided on a surface on the one side of the base portion and a peripheral portion positioned at a periphery of the pupil portion and inclined at a predetermined angle toward the one side from the pupil portion;
generating instruction data for instructing a 3D printer to shape the eye member based on the 3D data; and
shaping the eye member by causing the 3D printer to eject a shaping material based on the instruction data.

7. A three-dimensional shaped object comprising the eye member according to claim 6.

8. An eye member, comprising:
an eyeball portion that imitates an eyeball, wherein the eyeball portion includes
a base portion, and
a covering portion positioned on one side of the base portion so as to cover the base portion,
wherein the base portion includes
a pupil portion provided on a surface on the one side of the base portion, and
a peripheral portion positioned at a periphery of the pupil portion and inclined at a predetermined angle toward the one side from the pupil portion,
wherein the base portion and the covering portion are made of materials having different appearances, and
wherein the base portion and the covering portion are integrally formed.

9. The eye member according to claim 8, wherein the eye member includes a body region that is in contact with the eyeball portion and imitates a surrounding portion of the eyeball,
the eyeball portion and the body region are made of materials having different appearances, and
the eyeball portion and the body region are integrally formed.

10. A three-dimensional shaped object comprising the eye member according to claim 8.

11. The eye member according to claim 8, wherein the covering portion includes a first surface that is exposed to an outside and is not in contact with the pupil portion, and the first surface has a curved surface shape.

12. The eye member according to claim 11, wherein the pupil portion is positioned at a predetermined distance on an opposite side relative to the first surface of the covering portion.

13. The eye member according to claim 8, wherein the pupil portion has a curved surface shape.

14. The eye member according to claim 8, wherein the pupil portion corresponds to a vertex of a corner formed by the peripheral portion in the base portion.

15. The eye member according to claim 8, wherein the base portion further includes, at a further periphery of the peripheral portion, a portion having an appearance different from that of the peripheral portion.

16. The eye member according to claim 8, wherein the pupil portion and the peripheral portion are made of materials that differ in at least one of material, color, and transparency.

17. The eye member according to claim 8, wherein the covering portion is made of a material that transmits light.

18. The eye member according to claim 11, wherein the covering portion further includes a second surface that is not in contact with the pupil portion, and a region between the second surface and the pupil portion is filled with a light-transmitting material or is hollow.

19. The production method according to claim 1, further comprising:
selectively ejecting a plurality of different shaping materials assigned to respective portions of the eye member.

20. The three-dimensional shaped object according to claim 10, wherein the three-dimensional shaped object imitates a character.
